(19) United States
(12) Patent Application Publication
(10) Pub. No.: US 2003/0172790 A1
(43) Pub. Date: Sep. 18, 2003

(54) Motion mechanism for machine tools

(76) Inventor: Christoph Schmidt, Stuttgart (DE)

Correspondence Address: STEPHEN P. SCUDERI, PEPE & HAZARD, LLP, 225 ASYLUM ST., HARTFORD, CT, 06103, US

(21) Appl. No.: 10/384,476

(22) Filed: Mar. 7, 2003

(30) Foreign Application Priority Data
Mar. 9, 2002 (EP) 02 005 488.8

(51) Int. Cl. B26D 5/08

(52) U.S. Cl. 83/523

(57) ABSTRACT

Motion mechanism for machine tools, and machine tool with such a motion mechanism. A drive assembly installed on machine tools includes at least one drive unit (18, 25) and, at least one motion guide (6,7) associated with the drive unit (18, 25). The drive unit (18, 25) includes at least one toothed rack (16, 23) and, meshing therewith, at least one drive pinion (17, 24). Components of the motion guide (6, 7) include at least one support structure (8, 3) as well as multiple guide units (10, 21) positioned along the support structure (8, 3) and jointly movably by a drive unit (18, 25). The toothed rack (16, 23) encompasses toothed segments (15, 22) that are at least partially integrated in at least part of the guide units (10, 21), and the guide units concerned (10, 21) are kept in alignment relative to one another so as to form the toothed rack (16, 23).

### BACKGROUND OF THE INVENTION

The present invention relates to a motion mechanism for machine tools including at least one drive unit and at least one motion guide associated with the drive unit with at least one toothed rack meshing with at least one drive pinion, and the motion guide includes at least one support structure along which multiple guide elements are positioned so as to be jointly movable by the drive unit.

The state of the art machine design of this type is a machine tool marketed by Trumpf Werkzeugmaschinen GmbH & Co. KG of 71254 Ditzingen, Germany under the model number “TC 5000 R”, and illustrated and described in my co-pending application Ser. No. 10/040,002 filed Nov. 9, 2001. This prior art machine features a drive mechanism in the form of an X-Y coordinate drive which serves to move sheet metal workpieces relative to punching or stamping station during processing, and to move cutting or stamping tools into switching or processing positions. Both the workpiece and the cutting tools move in a horizontal plane defined by the coordinate X- and Y-axes. A separate motion guide is provided for each of these directional axes. In the direction of the X-axis, guide units moving along a support rail are equipped with clamping shoes for the sheet metal workpiece to be processed and with cartridges containing the cutting tools which can be changed automatically. For movement in the direction of the Y-axis, the X-axis guide can be laterally shifted along the machine frame. To accomplish this function, guide units are connected to the X-axis motion guide, and support rails on the machine frame extend in the Y-direction and along which travel the Y-axis guide units. The X-axis guide units and the Y-axis guide units are each individually movable by a separate rack and pinion drive system composed of a fixed drive pinion engaging a rack that is mounted on, and jointly moves with, the respective guide unit.

Accordingly, it is an object of the present invention to provide a machine tool drive assembly which is relatively simple to assemble and maintain.

It is also an object to provide a machine tool incorporating such a drive assembly.

### SUMMARY OF THE INVENTION

I has now been found that the foregoing and related objects may be readily attained in a drive assembly for machine tools with at least one drive unit (18, 25) and at least one motion guide (6, 7) cooperating with the drive unit (18, 25). The drive unit (18, 25) includes at least one toothed rack (16, 23, 223) meshing with at least one drive pinion (17, 24), and the motion guide (6, 7) includes at least one support structure (8, 3) and multiple guide units (10, 21, 221) guided along the support structure (8, 3) and jointly movable by means of the drive unit (18, 25). The toothed rack (16, 23, 223) is comprised of a plurality of toothed segments (15, 22, 222) at least partly integrated with some of the guide units (10, 21, 221), and the respective guide units (10, 21, 221) are adjustable and fixed relative to one another to constitute the toothed rack.

Preferably, the toothed segments (15, 22, 222) are integratatly formed with the respective guide units (10, 21, 221). The guide units (10, 21) are maintained in alignment with each other by (i) at least one tension rod (26, 27) extending through them in their direction of travel (9, 19), or (ii) by at least one tie bar (28, 29) flush-mounted on their outer surface, or (iii) by overlapping rabbet-type surfaces, or (iv) by seating snugly in essentially clearance-free fashion on the support structure.

The guide units (10, 21, 221) provided with toothed segments (15, 22, 222) of the toothed rack (16, 23, 223) are supported on an inner surface opposite the support structure (8, 3) and the toothed segments (15, 22, 222) are provided on and fully integrated into the outer surface thereof opposite the inner support surface of the guide units (10, 21, 221). Desirably, the guide units (10, 21, 221) providing the toothed segments (15, 22, 222) are identical.

The drive assembly is mounted in a machine tool having a processing station and a feed system for moving at least one workpiece (13) and/or at least one processing tool (14) in the direction of at least one axis of travel (9, 19) relative to the processing station. The feed system includes at least one motion guide (6, 7) in which the guide units (10, 21, 221) composed of the toothed segments (15, 22, 222) of the toothed rack (16, 23, 223) are guides are positioned along the support structure (8, 3) in the direction of an axis of travel (9, 19). These guide units are connected with the workpiece (13) and/or processing tool(s) (14) so as to travel in unison therewith.

The feed system includes a coordinate guide (5) to move at least one workpiece (13) and/or at least one processing tool (14) in the directions of two perpendicular axes of travel (9, 19) relative to the processing station. The feed system also includes as motion guides two directional guides (6, 7) to move the workpiece(s) (13) and/or the processing tool(s) (14). The first directional guide (6) effects movement in the direction of the first axis of travel (9) and the second directional guide (7) cooperating with the first directional guide (6) to effect movement in the direction of the second axis of travel (19). At least one of the directional guides (6, 7) comprises guide units (10, 21, 221) providing the toothed segments (15, 22, 222) of the toothed rack (16, 23, 223) and connected to the workpiece(s) (13) and/or the processing tool(s) (14).

As can be seen, the guide units in the motion mechanism are more than just part of the motion guide and also constitute part of the associated drive system. This reduces the number of components needed to move the guide units. Consequently, the overall system is compact, and its bulk and intrinsic weight are minimized. Since the drive pinions engage directly in the respective guide units, the path traveled by the motive force needed to drive the guide units is very short and easily optimizable in adaptation to the loads to be moved. As a net result, the motion mechanism of this invention and the machine tool based on the invention permit high-speed movement coupled with high precision.

The toothed sections of the rack are totally integrated segments of the guide units concerned.

The motion mechanism enables mutual adjustment of the guide units that incorporate toothed rack segments, and thus of the toothed segments themselves. The tension rod and tie bar enable the guide units to be locked in a defined position relative to one another both in the direction of travel and in the transverse direction. The mutual alignment of the guide units in the direction transverse to their direction of travel is provided by the support structure so that additional adjustment provisions for the mutual alignment and retention of the guide units are needed only in the direction of travel.

Motive force components exerting energy in the direction transverse to the direction of travel can be deflected into the associated support structure without subjecting the guide units to any tilting pressure.

Using identical guide units as provided for in an enhanced design version of the invention makes it possible to combine individual guide units in any desired fashion. When such identical guide units are employed, it takes only a minimal effort, to replace a damaged guide unit with another such unit. Guide units that incorporate additional functional features such as workpiece clamping devices or tool holders can be repositioned at will within a row of guide units without in any way compromising the functionally reliable interaction with the toothed segments of the individual guide units.

The motion mechanism may move workpieces and/or cutting tools relative to the processing stations of machine tools. For multi-axis movements in machine tools using a coordinate axis guide system employing for each axis of travel guide carriages with at least partially integrated toothed segments, the result will be a cumulative combination of the advantageous features offered by the invention.

### BRIEF DESCRIPTION OF THE DRAWINGS

FIG. 1 is a fragmentary view in partial cross section of a machine tool incorporating a motion mechanism embodying the present invention with an X-axis guide and a Y-axis guide;

FIG. 2 is a top plan view of the motion mechanism in the machine tool of FIG. 1;

FIGS. 3 and 4 are cross sectional illustrations of the X-axis guide of FIGS. 1 and 2 and drawn to an enlarged scale;

FIG. 5 is a cross sectional illustration of the Y-axis guide of FIGS. 1 and 2 and drawn to an enlarged scale;

FIGS. 6 and 7 illustrate a second embodiment of an X-axis guide shown in FIGS. 3 and 4;

FIG. 8 illustrates a second embodiment of the Y-axis guide shown in FIG. 5;

FIG. 9 is a top plan view of the Y-axis guide of FIG. 8;

FIG. 10 illustrates a third embodiment of the Y-axis guide shown in FIGS. 5 and 8;

FIG. 11 illustrates a fourth embodiment of the Y-axis guide shown in FIGS. 5, 8 and 10; and

FIGS. 12 and 13 illustrate a fifth embodiment of the Y-axis guide shown in FIGS. 8 and 9.

### DETAILED DESCRIPTION OF THE ILLUSTRATED EMBODIMENT

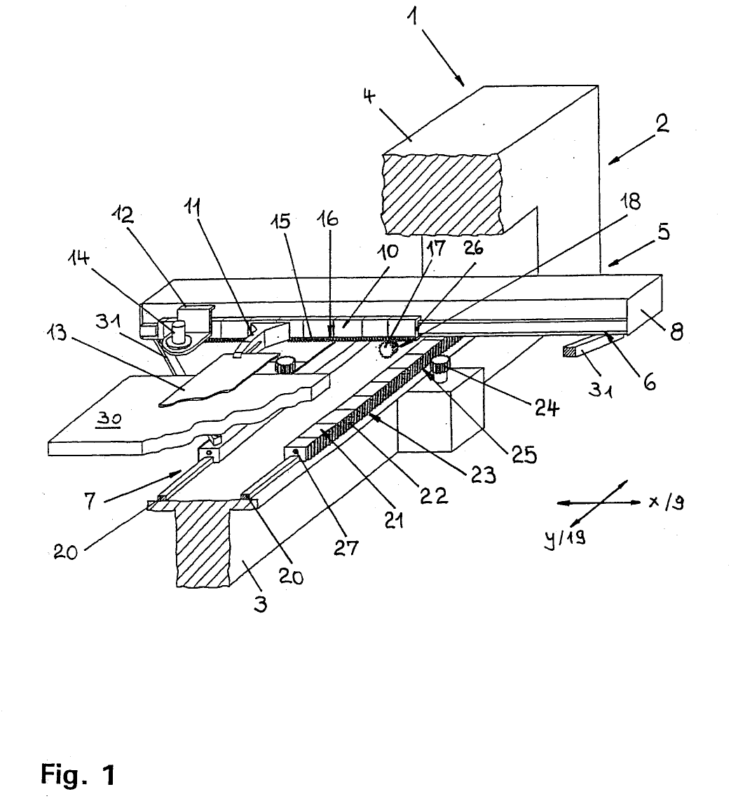

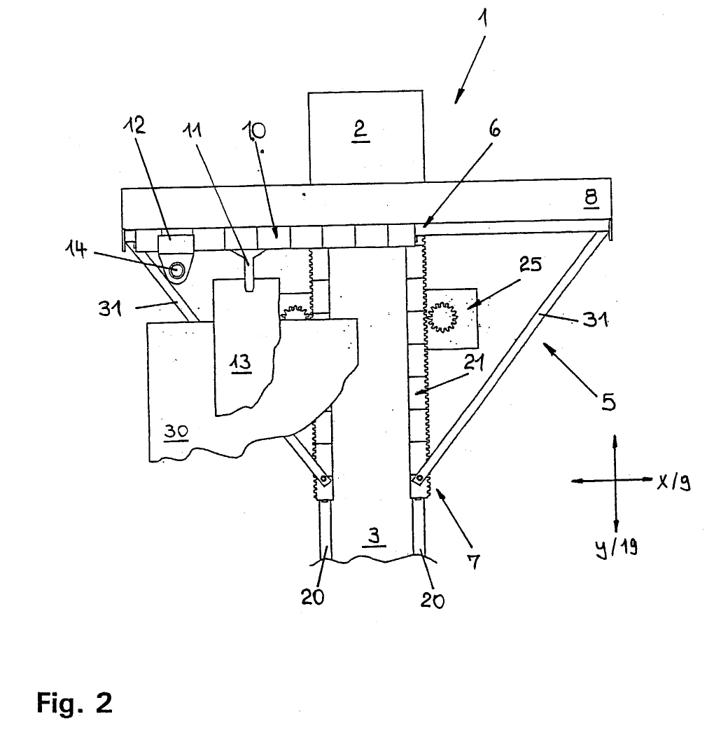

As shown in FIG. 1, a machine tool in the form of a stamping machine or punch press 1 includes a C-shaped frame 2 with a lower arm 3 and an upper arm 4. FIG. 1 fragmentarily illustrates both frame arms 3 and 4.

The processing (i.e. punching or stamping) station of the stamping machine 1 is not illustrated but is provided between the open ends of the arms 3 and 4. The stamping station is of a conventional design in which the lower arm 3 includes a tool holder for the bottom stamping die and the upper arm 4 includes a tool holder for the top stamping die.

The throat of the stamping machine 1 between the lower arm 3 and the upper arm 4 of the C-frame accommodates a motion mechanism in the form of an X-Y coordinate drive 5 that includes a first motion guide in the form of an X-axis guide 6 and a second motion guide in the form of a Y-axis guide 7.

The support element of the X-axis guide 6 is the X-rail 8 that extends in the direction of the first axis of travel, i.e., the X-axis 9. In the direction of the X-axis 9, the X-rail 8 carries a multiplicity of movable, motor-driven guide units or guide carriages 10. Some guide carriages 10 are provided with clamps 11, and others are provided with tool cartridges 12. The clamps 11 serve in conventional fashion to hold a workpiece in the form of a metal plate 13. Each of the tool cartridges 12 holds a multi-component processing tool in the form of a punching die or stamping die 14. On their lower face, the guide carriages 10 are provided with toothed segments 15 contoured or, in the case of the example illustrated, milled, into the bottom surface.

The toothed segments 15 on the guide carriages 10 consecutively extending in the direction of the X-axis 9 abut one another in that direction, thus forming a contiguous, offset-free toothed rack 16. The rack 16 meshes with a drive pinion 17 that is mounted on the shaft of a drive motor positioned adjacent the X-rail 8. The pinion 17 and the rack 16 (i.e., the toothed segments 15) constitute components of a drive system in the form of an X-drive 18 by means of which the guide carriages 10 can be moved along the X-rail 8 in the direction of the X-axis 9.

In the direction of the X-axis 9, the X-rail 8 is stationary. In the direction of the second axis of travel, i.e., the Y-axis 19, the X-rail 8 can be moved by the Y-guide 7. The lower arm 3 of the frame has guide rails 20 provided on its top surface, and it serves as the support element for the Y-guide 7. Movable along the guide rail 20 on the lower arm 3 are guide units in the form of guide carriages 21, some of which support the X-rail 8. All guide carriages 21 are provided on the outer surface with toothed segments 22 which, in the same way as the toothed segments 15 on the guide carriages 10, are machined into the respective outer surface. The toothed segments 22 form a continuous toothed rack 23 that meshes with the drive pinion 24 which is mounted on the shaft of a stationary drive motor 35. These components make up a drive system in the form of a Y-drive 25 by means of which the X-rail 8 can be moved in the direction of the Y-axis 19.

As is shown in FIGS. 1 and 3 to 5, the guide carriages 10 of the X-guide 6 are connected by a tension rod 26, and the guide carriages 21 of the Y-guide 7 are connected by a tension rod 27. The tension rod 26 extends in the direction of the X-axis 9, and the tension rod 27 extends in the direction of the Y-axis 19. The tension rods 26 and 27 serve the purpose of ensuring that, in their respective direction of travel, the toothed segments 15, 22 constitute contiguous and offset-free toothed racks 16, 23. Where necessary to provide a uniform tooth spacing, it is possible to place appropriate spacers between individual guide carriages. The mutual alignment of the individual guide carriages 10 or 21, is also provided by their support, respectively on the X-rail 8 and the lower arm 3 of the frame. In the direction transverse to the direction of travel of the guide carriages 10, 21, in the X-axis 9 and to the Y-axis 19, that support is essentially without any clearance or backlash. Sliding the guide carriages 10, 21 onto their respective support element aligns the guide carriages 10, 21, so that the toothed segments 15, 22 form bump-free contiguous toothed rods 16, 23 in the transverse direction relative, respectively, to the X-axis 9 and the Y-axis 19.

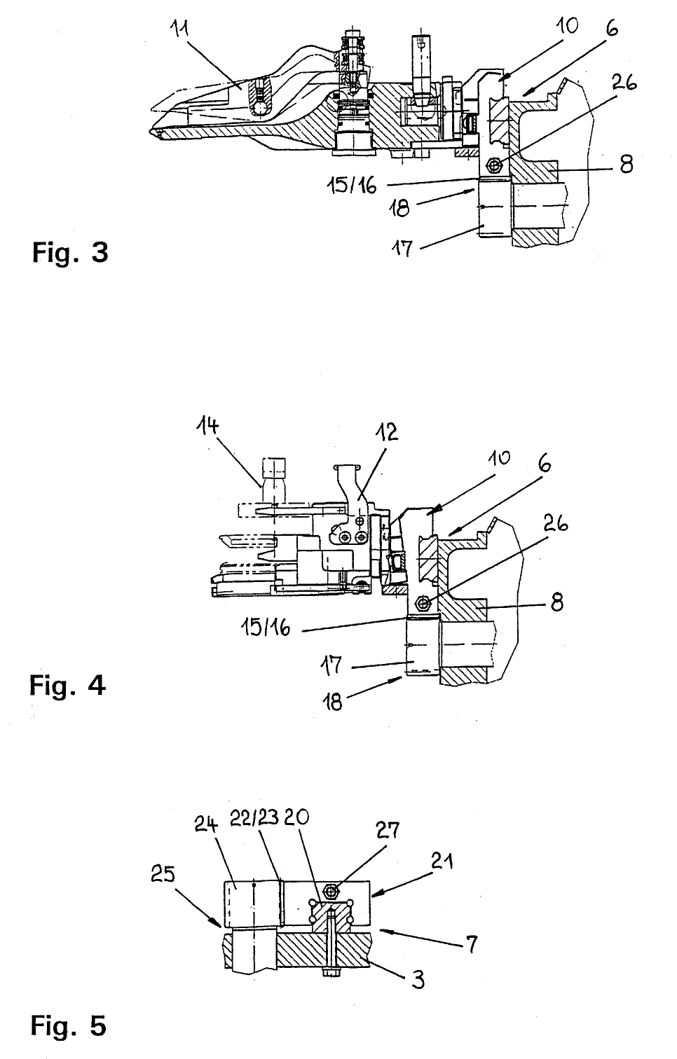

As can be seen in the detailed drawings of FIGS. 3, 4 and 5, the toothed segments 15, 22 are provided on the outer surface of the guide carriages 10, 21, i.e., they are located opposite the support of the guide carriages 10, 21 on the associated X-rail 8 or guide rail 20 on the lower arm 3 of the frame 2. Accordingly, the motive force that moves the guide carriages 10, 21 bears directly on the side surface opposite the support of the guide carriages 10, 21.

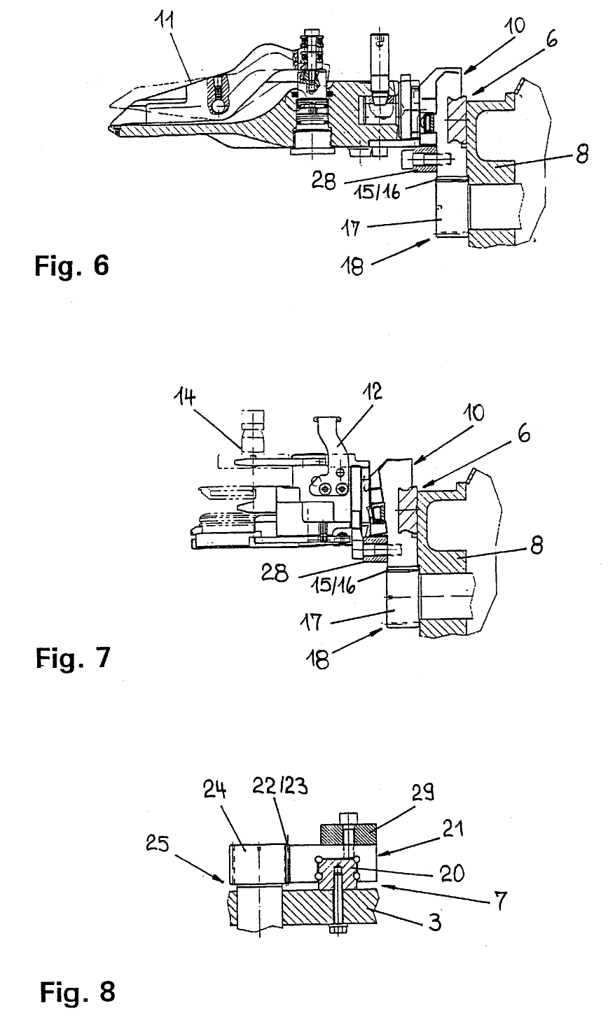

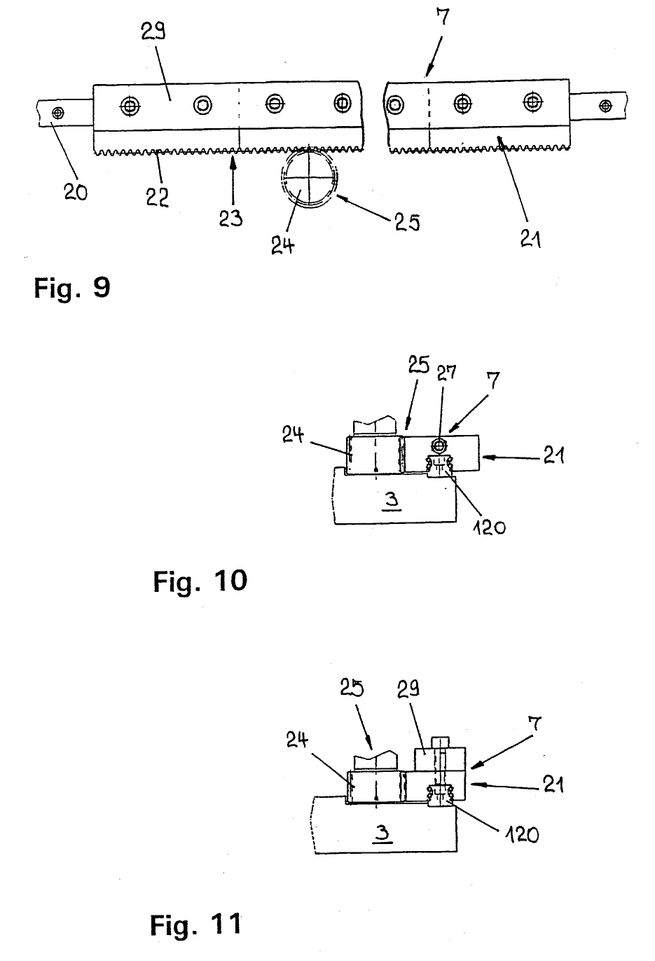

FIGS. 6 and 7 show that, for connecting the guide carriages 10 to form a contiguous, offset-free toothed rack 16 composed of the toothed segments 15, it is possible to use a tie bar 28 in place of the tension rod 26. In this case the tie bar 28 is fastened to the outside of the guide carriages 10 by fasteners 50. Similarly, as shown in FIGS. 9 and 10, a tie bar 29 can be used in place of the above-described tension rod 27 for connecting the guide carriages 21 of the Y-guide 7.

When compared to the assemblies of FIGS. 5 and 6, the assemblies of FIGS. 10 to 13 illustrate different design variations of the Y-guide 7. In these assemblies, the drive pinion 24 is positioned on the lower end of a vertically oriented motor shaft. Another modification of the design of FIGS. 5 and 6 is the cross-sectional profile of the guide rails 120 of the lower arm 3 of the frame 2 supporting the guide carriages 21 or, respectively, the carriages 221 of the Y-guide 7 on a lateral shoulder.

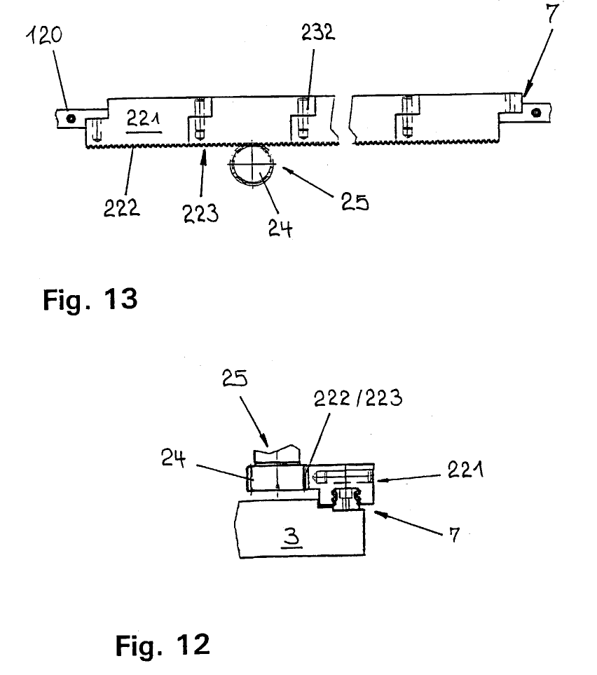

As shown in FIGS. 12 and 13, the guide carriages 221 of the Y-guide 7 are configured differently from the guide carriages 21. Specifically, the guide carriages 221 extending in the direction of the Y-axis 19 are fastened together at rabbet-type overlapping portions 232. The toothed segments 222 which are machined into the guide carriages 221 thus combine into a continuous, offset-free toothed rack 223. In FIG. 12 the toothed segments 222 are provided on lateral projections of the guide carriages 221. The guide carriages of the X-guide 6 can be configured in an analogous manner. In general it is possible to combine the different design variations of the X-guide 6 and of the Y-guide 7 in any desired manner.

During the operation of the stamping machine 1, typically under numerical control, the X-Y coordinate guide 5 moves and positions the metal plate 13 and the stamping dies 14 relative to the processing station (not illustrated) along the plane defined by the X-axis 9 and the Y-axis 19. The stamping dies 14 which are held in place on the X-rail 8 can thus be inserted into or removed from the tool holders in the stamping station. The essentially conventional procedure is described in detail for instance in German Patent Publication A-38 18 001. When moved in the direction of the X-axis 9, the metal plate 13 slides on a workpiece processing platform 30 that is supported by guide carriages 21, 221 of the Y-guide 7 and is then transported in the direction of the Y-axis 19. Braces 31 serve to reinforce the X-Y coordinate guide system 5.

Thus, it can be seen from the foregoing detailed specification and attached drawings that the novel motion mechanism of the present invention may be readily assembled and maintained. Various structures may be employed to couple the guide units.

Having thus described the invention, what is claimed is:

1. A drive assembly for machine tools with at least one drive unit (18, 25) and at least one motion guide (6, 7) cooperating with the drive unit (18, 25), said drive unit (18, 25) including at least one toothed rack (16, 23, 223), meshing with at least one drive pinion (17, 24), and said motion guide (6, 7) includes at least one support structure (8, 3) and multiple guide units (10, 21, 221) guided along the support structure (8, 3) and jointly movable by means of the drive unit (18, 25), said toothed rack (16, 23, 223) comprising a plurality of toothed segments (15, 22, 222) at least partly integrated with some of the guide units (10, 21, 221), the respective guide units (10, 21, 221) being adjustable and fixed relative to one another to constitute the toothed rack (16, 23, 223).

2. The drive assembly in accordance with claim 1, wherein the toothed segments (15, 22, 222) are integrally formed with the respective guide units (10, 21, 221).

3. The drive assembly in accordance with claim 1 wherein said guide units (10, 21) are maintained in alignment with each other by at least one tension rod (26, 27) extending through them in their direction of travel (9, 19).

4. The drive assembly in accordance with claim 1 wherein said guide units (10, 21) are maintained in alignment with each other by at least one tie bar (28, 29) flush-mounted on their outer surface.

5. The drive assembly in accordance with claim 1 wherein said guide units (221) are maintained in alignment with each other by overlapping rabbet-type surfaces.

6. The drive assembly in accordance with claim 1 wherein said guide units (10, 21, 221) are maintained in alignment with each other by seating snugly in essentially clearance-free fashion on the support structure (8, 3).

7. The drive assembly in accordance with claim 1 wherein said guide units (10, 21, 221) provided with toothed segments (15, 22, 222) of the toothed rack (16, 23, 223) are supported on an inner surface opposite said support structure (8, 3) and said toothed segments (15, 22, 222) are provided on and fully integrated into the outer surface thereof, opposite the said inner support surface of the guide units (10, 21, 221).

8. The drive assembly in accordance with claim 1 wherein said guide units (10, 21, 221) providing said toothed segments (15, 22, 222) are identical.

9. The drive assembly in accordance with claim 1 wherein said drive assembly is mounted in a machine tool having a processing station and a feed system for moving at least one workpiece (13) and/or at least one processing tool (14) in the direction of at least one axis of travel (9, 19) relative to said processing station, said feed system including at least one motion guide (6, 7) in which said guide units (10, 21, 221) providing toothed segments (15, 22, 222) of the toothed rack (16, 23, 223) are guides along the support structure (8, 3) in the direction of an axis of travel (9, 19) and are connected with the workpiece (13) and/or processing tool(s) (14) so as to travel in unison therewith.

10. The drive assembly in accordance with claim 9 wherein said feed system includes a coordinate guide (5) to move at least one workpiece (13) and/or at least one processing tool (14) in the directions of two perpendicular axes of travel (9, 19) relative to a processing station, said feed system also including as motion guides two directional guides (6, 7) to move the workpiece(s) (13) and/or the processing tool(s) (14), the first directional guide (6) effecting movement in the direction of the first axis of travel (9) and the second directional guide (7) cooperating with the first directional guide (6) to effect movement in the direction of the second axis of travel (19), at least one of said directional guides (6, 7) comprising guide units (10, 21, 221) providing said toothed segments (15, 22, 222) of the toothed rack (16, 23, 223) are connected to at least one of the group consisting of, the workpiece(s) (13), the processing tool(s) (14) and the first directional guide (6).

11. A machine tool having a processing station and a feed system for moving at least one workpiece (13) and/or at least one processing tool (14) in the direction of at least one axis of travel (9, 19) relative to said processing station, said feed system including at least one drive unit (18, 25) and at least one motion guide (6, 7) cooperating with the drive unit (18, 25), said drive unit (18, 25) including at least one toothed rack (16, 23, 223), meshing with at least one drive pinion (17, 24), and said motion guide (6, 7) includes at least one support structure (8, 3) and multiple guide units (10, 21, 221) guided along the support structure (8, 3) and jointly movable by means of the drive unit (18, 25), said toothed rack (16, 23, 223) comprising toothed segments (15, 22, 222) at least partly integrated along with some of the group of the guide units (10, 21, 221), the respective guide units (10, 21, 221) being adjustable and fixed relative to one another to constitute the toothed rack (16, 23, 223), said guide units (10, 21, 221) providing said toothed segments (15, 22, 222) of the toothed rack (16, 23, 223) being positioned along their associated support structure (8, 3) in the direction of an axis of travel (9, 19) and are connected with the workpiece (13) and/or processing tool(s) (14) so as to travel in unison therewith, said toothed segments (15, 22, 222) being integrally formed with the respective guide units (10, 21, 221).

12. The machine tool in accordance with claim 11 wherein said guide units (10, 21) are maintained in alignment with each other by at least one tension rod (26, 27) extending through them in their direction of travel (9, 19).

13. The machine tool in accordance with claim 11 wherein said guide units (10, 21) are maintained in alignment with each other by at least one tie bar (28, 29) flush-mounted on their outer surface.

14. The machine tool in accordance with claim 11 wherein said guide units (221) are maintained in alignment with each other by overlapping rabbet-type surfaces.

15. The machine tool in accordance with claim 11 wherein said guide units (10, 21, 221) provided with toothed segments (15, 22, 222) of the toothed rack (16, 23, 223) are supported by an inner surface opposite said support structure (8, 3) and said toothed segments (15, 22, 222) are provided on and integral with the outer surface thereof, opposite the said inner support surface of the guide units (10, 21, 221).

16. The machine tool in accordance with claim 11 wherein said guide units (10, 21, 221) providing said toothed segments (15, 22, 222) are identical.

17. The machine tool in accordance with claim 11 wherein said feed system includes coordinate guide (5) to move at least one workpiece (13) and/or at least one processing tool (14) in the directions of two perpendicular axes of travel (9, 19) relative to a processing station, said feed system also including as motion guides two directional guides (6, 7) to move the workpiece(s) (13) and/or the processing tool(s) (14), the first directional guide (6) effecting movement in the direction of the first axis of travel (9) and the second directional guide (7) cooperating with the first directional guide (6) to effect movement in the direction of the second axis of travel (19), at least one of said directional guides (6, 7) comprising guide units (10, 21, 221) providing said toothed segments (15, 22, 222) of the toothed rack (16, 23, 223) are connected to at least one of the workpiece(s) (13), the processing tool(s) (14), and the first directional guide (6).
